(19) United States
(12) Patent Application Publication
(10) Pub. No.: US 2013/0141391 A1
(43) Pub. Date: Jun. 6, 2013

(54) TOUCH CONTROL DEVICE, TOUCH CONTROL SYSTEM, AND TOUCHING CONTROL METHOD THEREOF

(71) Applicants: JR-Shiung JANG, New Taipei City (TW); Shih-Che Chien, New Taipei City (TW); Yi-Shu Chen, New Taipei City (TW); You-Xin Liu, New Taipei City (TW)

(72) Inventors: JR-Shiung JANG, New Taipei City (TW); Shih-Che Chien, New Taipei City (TW); Yi-Shu Chen, New Taipei City (TW); You-Xin Liu, New Taipei City (TW)

(21) Appl. No.: 13/552,861

(22) Filed: Jul. 19, 2012

(30) Foreign Application Priority Data
Dec. 5, 2011 (TW) 100144713

(51) Int. Cl. G06F 3/042; H04W 88/00; G05B 19/02

(52) U.S. Cl. 345/175; 340/4.3; 455/41.2

(57) ABSTRACT

A touch control device, a touch control system, and a touching control method thereof are disclosed. The touch control device includes a light emission module, a first capture module, a second capture module, a computing module, and a first wireless transmission module. The light emission module projects a light signal to become a touch surface. When an object approaching the touch surface, the first capture module and the second capture module are used for capturing a first reflected signal and a second reflected signal according to reflect the light signal. The computing module is used for computing a first capturing angle and a second capturing angle according to the first reflected signal and the second reflected signal and computing a coordinate data of the object. The first wireless transmission module is used for transferring the coordinate data to a controlled system via a wireless transmission.

### BACKGROUND OF THE INVENTION

1. Field of the Invention

The present invention relates to a touch control device, a touch control system, and a touching control method thereof; more particularly, the present invention relates to a small-sized and independently-portable touch control device, a touch control system, and a touching control method thereof.

2. Description of the Related Art

With modern technology development, human-machine touch control interaction techniques have become essential applications to contemporary lives. Each kind of touch control types, such as resistance type, capacitance type, infrared type or sonic type techniques have been widely applied in various kinds of situations. However, the abovementioned touch control techniques are mostly applicable for small-sized handheld products. As for large-sized devices, such as electronic windows or electronic whiteboards, the manufacturing cost would be too high by applying the prior art. On the other hand, in the prior art, each type of touch control devices has to be connected to a hardware physical interface to achieve the touch control function. Therefore, the application of the touch control device would be limited, and cannot be freely applied to other controlled system.

Therefore, there is a need to provide a touch control device, a touch control system, and a touching control method thereof to achieve the objects of reducing the size, providing the portability and supporting multiple platforms, so as to mitigate and/or obviate the aforementioned problems.

### SUMMARY OF THE INVENTION

It is an object of the present invention to provide a touch control device which is small-sized and independently-portable.

It is another object of the present invention to provide a touch control system.

It is yet another object of the present invention to provide a touching control method.

To achieve the abovementioned objects, the touch control device of the present invention is used for allowing an object to control a controlled system via a wireless transmission. The touch control device comprises a light emission module, a first capture module, a second capture module, a computing module and a first wireless transmission module. The light emission module projects a light signal to form a touch surface. The first capture module is used for capturing a first reflected signal by reflecting the light signal when the object approaches the touch surface. The second capture module is used for capturing a second reflected signal by reflecting the light signal when the object approaches the touch surface. The computing module is electrically connected to the first capture module and the second capture module, and is used for computing a first capturing angle and a second capturing angle according to the first reflected signal and the second reflected signal, and then performs coordinate calculation so as to compute a coordinate data of the object. The first wireless transmission module is electrically connected to the computing module, and is used for transmitting the coordinate data to the controlled system via the wireless transmission.

The touch control system of the present invention is used for allowing an object to perform touch control operations. The touch control system comprises a touch control device and a controlled system. The touch control device comprises a light emission module, a first capture module, a second capture module, a computing module and a first wireless transmission module. The light emission module projects a light signal to form a touch surface. The first capture module is used for capturing a first reflected signal by reflecting the light signal when the object approaches the touch surface. The second capture module is used for receiving a second reflected signal by reflecting the light signal when the object approaches the touch surface. The computing module is electrically connected to the first capture module and the second capture module, and is used for computing a first capturing angle and a second capturing angle according to the first reflected signal and the second reflected signal, and then performs coordinate calculation so as to compute a coordinate data of the object. The first wireless transmission module is electrically connected to the computing module, and is used for transmitting the coordinate data. The controlled system comprises a second wireless transmission module, a conversion module and a control module. The second wireless transmission module is used for receiving the coordinate data from the first wireless transmission module. The conversion module is electrically connected to the second wireless transmission module, and is used for converting the coordinate data into a control signal. The control module is electrically connected to the conversion module, and is used for processing the control signal.

The touching control method of the present invention comprises the following steps: projecting a light source to form a touch surface; capturing a first reflected signal by reflecting the light source when an object approaches the touch surface; capturing a second reflected signal by reflecting the light signal when the object approaches the touch surface; computing a first capturing angle and a second capturing angle according to the first reflected signal and the second reflected signal; performing coordinate calculation to compute a coordinate data of the object; transmitting the coordinate data to a controlled system via a wireless transmission; and converting the coordinate data into a control signal to control the controlled system.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a structural schematic drawing of a touch control system according to the present invention.

FIG. 2 illustrates a schematic drawing of using a touch control device according to the present invention.

FIG. 2A illustrates a schematic drawing showing capturing angles of the touch control device according to the present invention.

FIG. 3 illustrates a flowchart of setting up the touch control device according to the present invention.

FIG. 4A illustrates a schematic drawing showing the touch control device capturing a plurality of positioning coordinates according to the present invention.

FIG. 4B illustrates a schematic drawing showing the touch control device setting up a detectable area according to the present invention.

FIGS. 5A-5B illustrate flowcharts of the touching control method according to the present invention.

### DETAILED DESCRIPTION OF THE PREFERRED EMBODIMENT

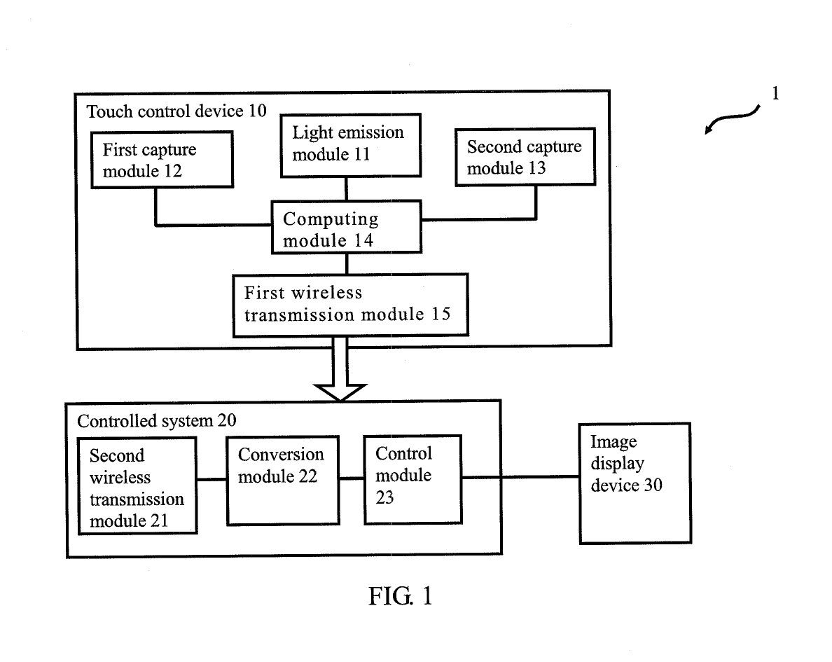

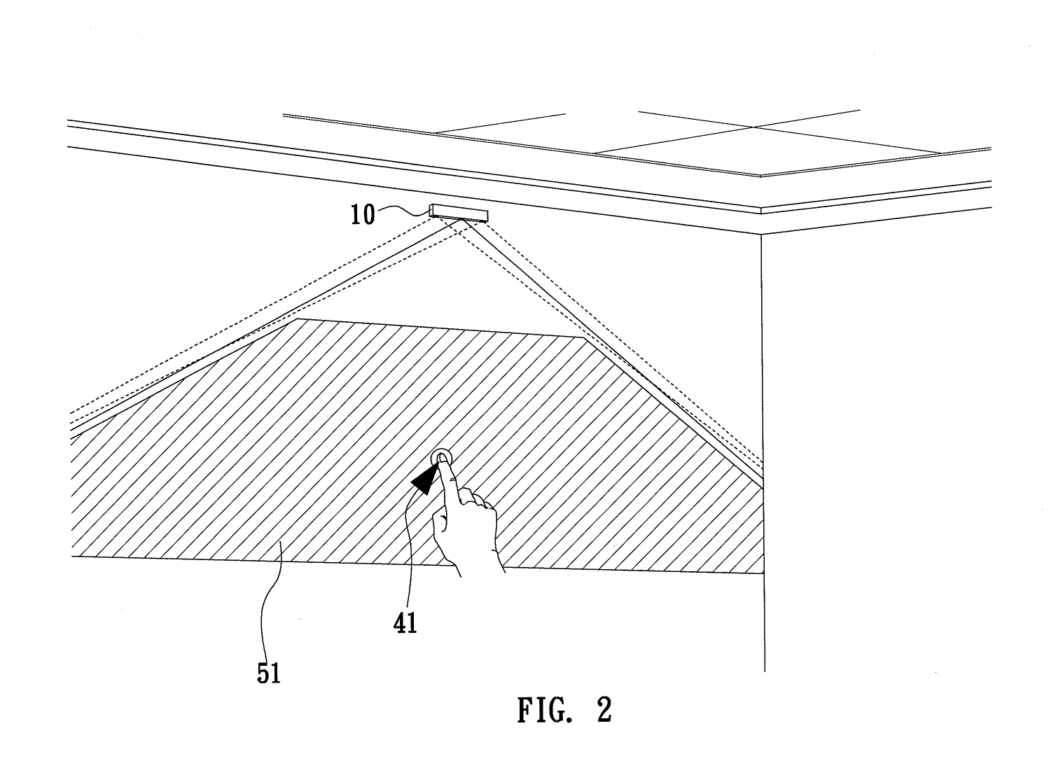

Please refer to FIG. 1, which illustrates a structural schematic drawing of a touch control system according to the present invention.

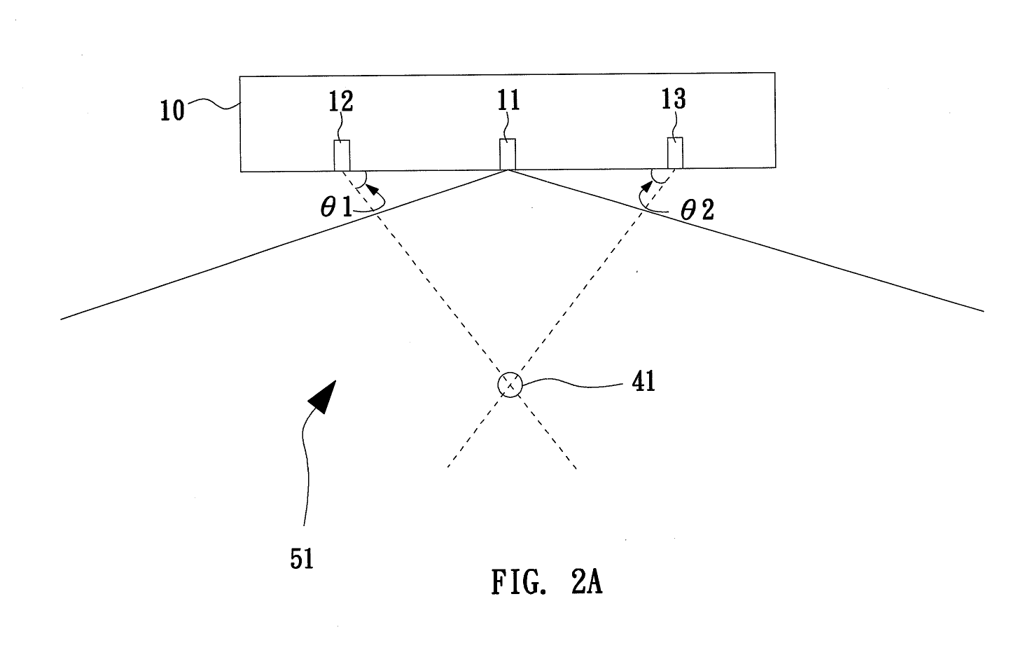

The touch control system 1 of the present invention comprises a touch control device 10 and a controlled system 20 connected with each other via a wireless transmission. The wireless transmission can be, but not limited to, Bluetooth communication. The touch control device 10 is used for allowing an object 41 (as shown in FIG. 2) to perform touch control operations, so as to control the controlled system 20 by means of wireless transmission. The object 41 can be, but not limited to, a user's finger or a stylus.

The user can freely install the touch control device 10 to a ceiling, a wall or a tabletop to achieve the touch control object. Please also refer to FIG. 2, which illustrates a schematic drawing of using a touch control device according to the present invention. The touch control device 10 as shown in FIG. 2 is installed on the wall. The touch control device 10 comprises a light emission module 11, a first capture module 12, a second capture module 13, a computing module 14 and a first wireless transmission module 15.

The light emission module 11 can be composed of a light emitting element and a lens (not shown in figures), and is used for projecting a light signal to form a touch surface 51. The light signal is preferably, but not limited to, an invisible light signal which is capable of reducing noise influence. The light signal can also be a visible light signal which allows the user to identify a precise location of the touch surface 51. The projection angle of the light signal projected from the light emission module 11 is around 90 degrees to 150 degrees. In one preferred embodiment, the angle is 120 degrees without limiting the scope of the present invention. The angle of the light signal can be adjusted according to different requirements.

The first capture module 12 and the second capture module 13 can be composed of optical filters and sensing elements (now shown in figures). The first capture module 12 and the second capture module 13 are respectively disposed to two sides of the light emission module 11 with a distance of 5 centimeters to 50 centimeters. The distance can be adjusted according to the projection angle of the light emission module 11, and a capturable angle of the first capture module 12 and the second capture module 13. In one preferred embodiment of the present invention, the first capture module 12 and the second capture module 13 are 5 centimeters away from the light emission module 11, such that the overall volume of the touch control device 11 is reduced. The first capture module 12 and the second capture module 13 are used for capturing reflected light signals. Therefore, when the object 41 approaches the touch surface 51, the first capture module 12 and the second capture module 13 would respectively capture pulse signals, i.e. the first reflected signal and the second reflected signal, reflected by the object 41. The angles to be captured by the first capture module 12 and the second capture module 13 are, but not limited to, around 135 degrees to 225 degrees.

The computing module 14 can be, but not limited to, composed of hardware, hardware combined with firmware, or hardware combined with software. The computing module 14 is electrically connected to the first capture module 12 and the second capture module 13. After the first capture module 12 and the second capture module 13 respectively capture the first reflected signal and the second reflected signal, the computing module 14 can firstly perform a noise filtering process to filter out the pulse signals not representing the object 41 from the first reflected signal and the second reflected signal. For example, if the environment of the touch control device 10 is not in a flat surface or has other obstacles, it is likely that the first capture module 12 and the second capture module 13 would capture a plurality of pulse signals at the same time, wherein those pulse signals represent the noises influenced by the environment. As a result, the computing module 14 needs to filter out the noises from the first reflected signal and the second reflected signal in advance. Because the technique of noise filtering has been commonly applied by those skilled in the art, there is no need for further explanation.

Then, the computing module 14 can compute a first capturing angle θ1 and a second capturing angle θ2 according to the first reflected signal and the second reflected signal. As shown in FIG. 2A, which illustrates a schematic drawing showing capturing angles of the touch control device according to the present invention

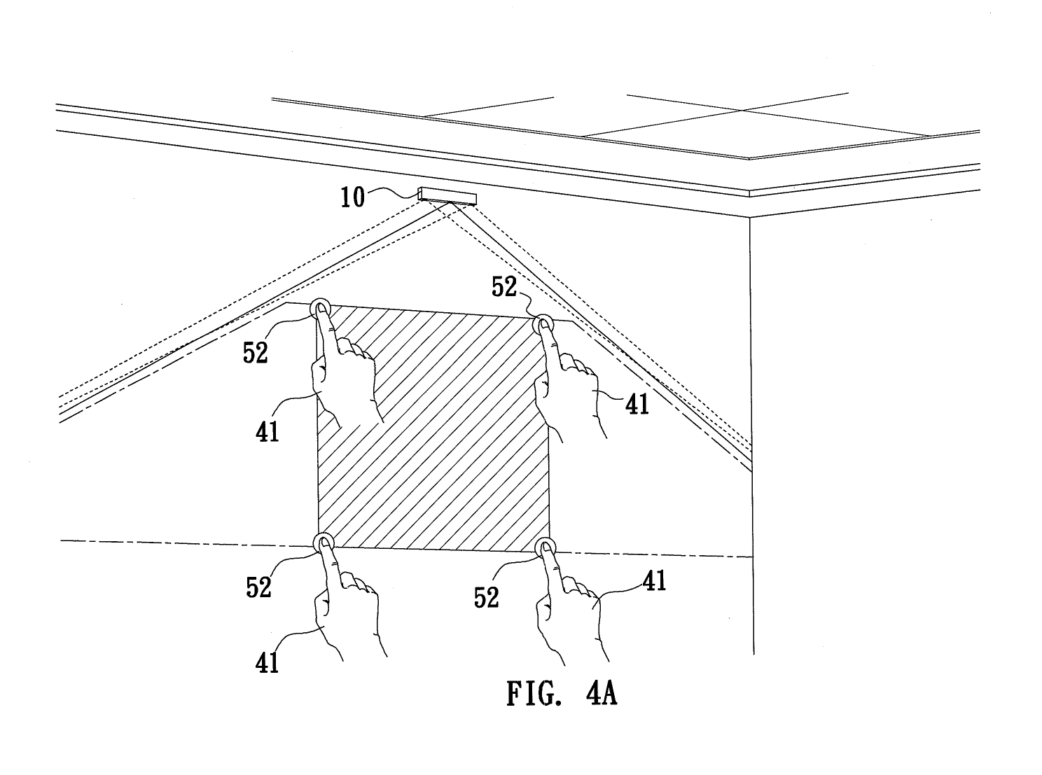

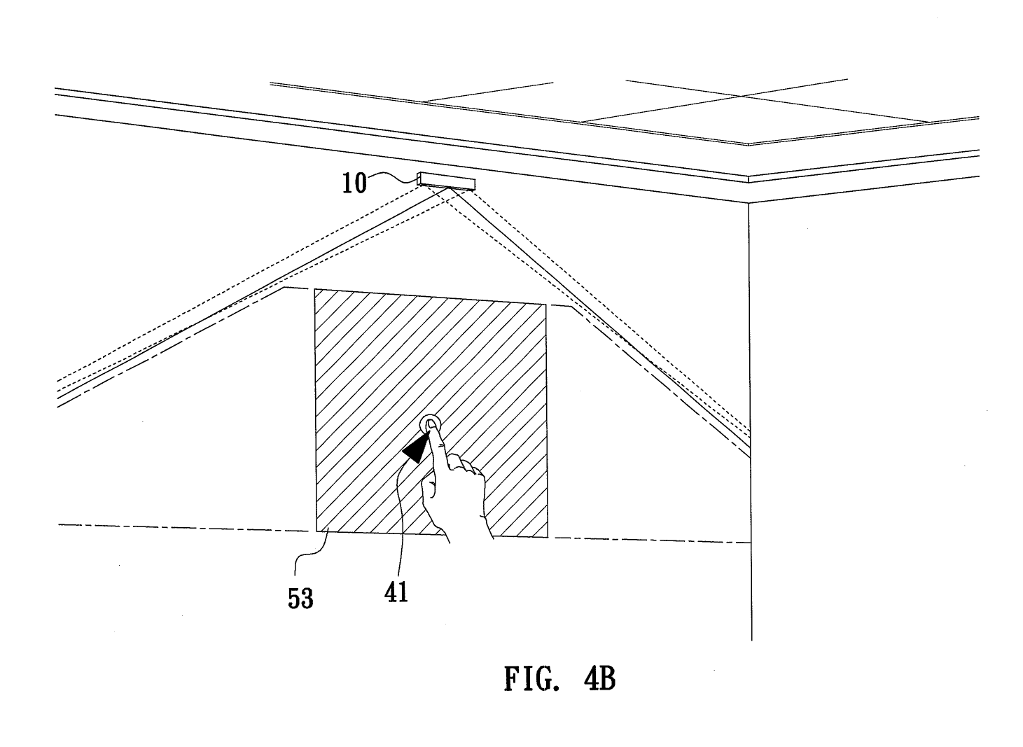

The computing module 14 computes the first capturing angle θ1 of the object 41 relative to the first capture module 12 according to the first reflected signal captured by the first capture module 12; meanwhile, the computing module 14 computes the second capturing angle θ2 of the object 41 relative to the second capture module 13 according to the second reflected signal captured by the second capture module 13. As a result, the computing module 14 can further compute coordinate data of the object 41 according to the first capturing angle θ1 and the second capturing angle θ2 by trigonometric functions or the like. Moreover, the computing module 14 can also set up a detectable area 53 (as shown in FIG. 4B) within a range of the touch surface 51. The method of setting up the detectable area 53 will be described in more detail later; therefore there is no need for further explanation here.

The first wireless transmission module 15 is, but not limited to, composed of hardware or hardware combined with firmware. The first wireless transmission module 15 is electrically connected to the computing module 14, and is used for transmitting signals to a second wireless transmission module 21 of the controlled system 20. In one embodiment of the present invention, the first wireless transmission module 15 and the second wireless transmission module 21 are transmission modules conforming to a Bluetooth communication protocol, so as to transmit data via Bluetooth communications, but please note the scope of the present invention is not limited to the above description. The first wireless transmission module 15 and the second wireless transmission module 21 can also transmit data via frequency-shift keying (FSK) or Gauss frequency shift keying (GFSK). Because the technique of wireless transmission has been commonly applied by those skilled in the art, there is no need for further explanation.

The controlled system 20 can be, but not limited to, a smart phone, a desktop computer, a laptop computer or a tablet computer. The controlled system 20 comprises the second wireless transmission module 21, a conversion module 22 and a control module 23.

The second wireless transmission module 21 is, but not limited to, composed of hardware or hardware combined with firmware. The second wireless transmission module 21 has the same communication protocol framework as the first wireless transmission module 15 does, so as to receive the coordinate data from the first wireless transmission module 15 by means of wireless transmission.

In one embodiment of the present invention, the conversion module 22 can be, but not limited to, a driver stored in a storage medium. The conversion module 22 can also be composed of hardware or hardware combined with firmware. The conversion module 22 is electrically connected to the second wireless transmission module 21, and is used for performing data format conversion to the coordinate data. For example, the coordinate data transmitted from the touch control device 10 might only be a two-dimensional coordinate, so the conversion module 22 would perform conversion to the coordinate data to make it conform to an operating system protocol with which the controlled system 20 is equipped.

On the other hand, the conversion module 22 can further used for performing resolution format conversion. For example, the coordinate data transmitted from the touch control device 10 might be a 1080P coordinate; however, the resolution displayed by the controlled system 20 is 320×240. Therefore, the conversion module 22 would convert the coordinate data to make it conform to the resolution format of the controlled system 20. As a result, after the resolution format conversion and the data format conversion, the conversion module 22 can convert the coordinate data into a control signal to be processed by the controlled system 20.

The control module 23 can be, but not limited to, composed of hardware, hardware combined firmware, or hardware combined with software. The control module 23 is electrically connected to the conversion module 22, and is used for receiving the control signal so as to perform follow-up processes to other internal modules of the controlled system 20.

According to the above description, the touch control device 10 can control the controlled system 20 only by transmitting two-dimensional coordinate data. In one preferred embodiment of the present invention, the bandwidth between the first wireless transmission module 15 and the second wireless transmission module 21 is only 9.6 Kps. Therefore, the bandwidth requirement of the touch control device 10 and the controlled system 20 can be lowered, and the distance between the touch control device 10 and the controlled system 20 can be extended as well.

In one embodiment of the present invention, the touch control system 1 can further comprise an image display device 30. The image display device 30 is electrically connected to the control module 23 of the controlled system 20, and is used for displaying an image signal. The image signal corresponds to the control signal, and can perform reaction according to the control signal. Please note that the controlled system 20 and the image display device 30 can be installed in the same device at the same time, such as being installed in a projection device or a display at the same time; or, the controlled system 20 and the image display device 30 can be independent devices, such as a laptop computer and a projection device connected with each other. But please also note the scope of the present invention is not limited to the above description.

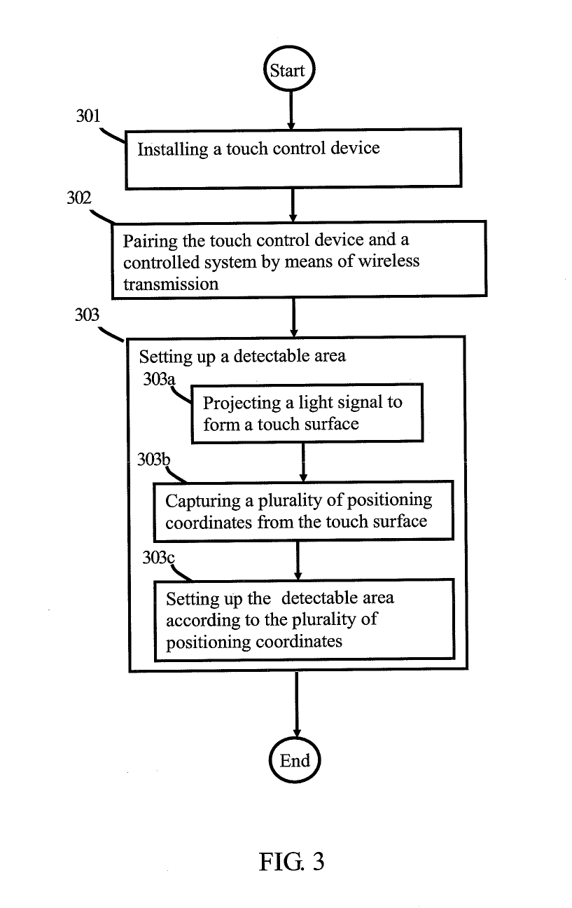

Please refer to FIG. 3, which illustrates a flowchart of setting up the touch control device according to the present invention. In this embodiment, the touch control system 1 having the touch control device 10 is used as an example to explain the method of setting up the touch control device, but please note the method of setting up the touch control device of the present invention is not limited to be used in the abovementioned touch control device 10 or the touch control system 1.

First, the method performs step 301: installing a touch control device.

At first, the touch control device 10 is installed in an environment with a plane, such as a tabletop, a wall or a piece of glass. If the image display device 30 is a display, the touch control device 10 can also be, but not limited to, directly installed on the image display device 30.

Next, the method performs step 302: pairing the touch control device and a controlled system via a wireless transmission.

Next, the touch control device 10 is connected to the controlled system 20 via a wireless transmission, such that the touch control device 10 and the controlled system 20 can transmit signals with each other. In one embodiment of the present invention, the touch control device 10 is connected to the controlled system 20 via Bluetooth communications; therefore, the controlled system 20 can treat the touch control device 10 as a Bluetooth device.

Finally, the method performs step 303: setting up a detectable area.

Then, the touch control device 10 can set up the detectable area 53 within the range of the touch surface 51 in advance, so as to filter out the range that does not need to be controlled.

The step of setting up the detectable area comprises firstly performing step 303a: projecting a light signal to form a touch surface.

At first, the light emission module 11 of the touch control device 10 projects the light signal which is scattered to form the touch surface 51.

Then, step 303b is performed by: capturing a plurality of positioning coordinates from the touch surface.

As shown in both FIG. 4A and FIG. 4B, wherein FIG. 4A illustrates a schematic drawing showing the touch control device capturing a plurality of positioning coordinates according to the present invention, and FIG. 4B illustrates a schematic drawing showing the touch control device setting up a detectable area according to the present invention.

The object 41 can sequentially set up a plurality of positioning points 52 from the touch surface 51, and then the first capture module 12 and the second capture module 13 sequentially capture reflected signals from the plurality of positioning points 52. Accordingly, the computing module 14 can compute a plurality of positioning coordinates. In the present invention, the positioning points 52 can be three or more points used for constituting a plane without being limited to the scope of four points as shown in FIG. 4A.

Finally, step 303c is performed by: setting up the detectable area according to the plurality of positioning coordinates.

Finally, after the computing module 14 computes the coordinates corresponding to the plurality of positioning points 52, the computing module 14 further defines the area constituted by the coordinates of the plurality of positioning points 52 as the detectable area 53. As a result, the computing module 14 only needs to transmit the coordinate data within the detectable area 53 to the controlled system 20.

If the touch control system 1 comprises the image display device 30, the range of the detectable area 53 can, but not limited to, correspond to the image signal displayed or projected by the image display device 30.

Please note that the touch control device 10 of the present invention can also directly detect the coordinate of the object 41 located within the touch surface 51, wherein it is not mandatory for the method of installing the touch control device 10 to perform step 303 to set up the detectable area 53.

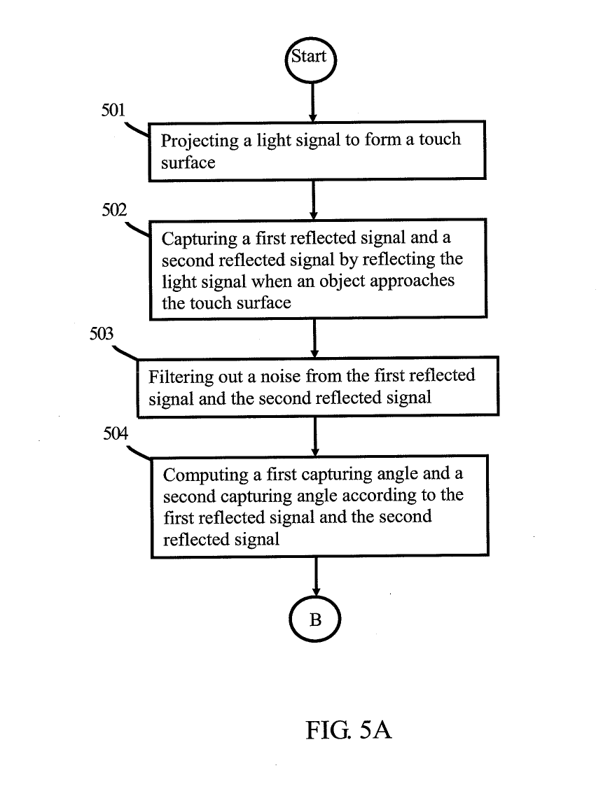

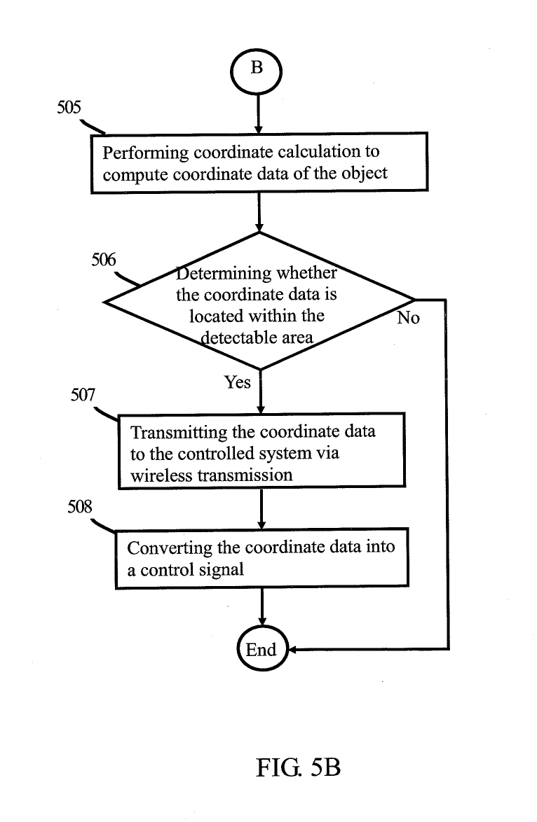

After the setup of the touch control device 10 is done, the user can perform touch control operations to the touch control device 10. Then, please refer to FIGS. 5A-5B, which illustrate flowcharts of the touching control method according to the present invention.

Firstly, the method performs step 501: projecting a light signal to form a touch surface.

At first, the light emission module 11 of the touch control device 10 projects the light signal which is scattered to form the touch surface 51.

Then, the method performs step 502: capturing a first reflected signal and a second reflected signal by reflecting the light signal when an object approaches the touch surface.

When the object 41 approaches the touch surface 51, it would reflect the light signal emitted from the light emission module 11, such that the first capture module 12 and the second capture module 13 can respectively capture the first reflected signal and the second reflected signal.

Then, the method performs step 503: filtering out a noise from the first reflected signal and the second reflected signal.

Then, the first capture module 12 and the second capture module 13 transmit the first reflected signal and the second reflected signal to the computing module 14. The computing module 14 firstly filters out the noise from the first reflected signal and the second reflected signal, so as to figure out the pulse signal representing the object 41.

Next, the method performs step 504: computing a first capturing angle and a second capturing angle according to the first reflected signal and the second reflected signal.

Further, according to the first reflected signal and the second reflected signal, the computing module 14 respectively computes the first capturing angle θ1 relative to the first capture module 12 and the second capturing angle θ2 relative to the second capture module 13.

Then, the method performs step 505: performing coordinate calculation to compute coordinate data of the object.

After obtaining the first capturing angle θ1 and the second capturing angle θ2, the computing module 14 can further compute a location of the object 41 relative to the touch control device 10, i.e. the coordinate data of the object 41, by trigonometric functions or the like.

And, the method performs step 506: determining whether the coordinate data is located within the detectable area.

After obtaining the coordinate data of the object 41, the computing module 14 performs comparison with the detectable area 53, so as to find out whether the coordinate of the object 41 is located within the detectable area 53. If the coordinate of the object 41 exceeds the range of the detectable area 53, the computing module 14 filters out the coordinate data, and ends the touch control process.

If the coordinate data is located within the detectable area 53, the method performs step 507: transmitting the coordinate data to the controlled system via wireless transmission.

Then, the computing module 14 transmits the coordinate data to the controlled system 20 by the first wireless transmission module 15 via the wireless transmission.

Finally, the method performs step 508: converting the coordinate data into a control signal.

Finally, the conversion module 22 performs resolution format conversion and data format conversion to the coordinate data to generate the control signal for the control module 23 to perform follow-up processes. For example, according to the control signal, the control module 23 can control the image display device 30 to display a corresponding image signal, or control an audio device (not shown in figures) to generate a sound effect. Please note that the actions controlled by the control module 23 are not limited by the present invention.

Please note the scope of the touching control method of the present invention is not limited to the abovementioned order or execution. It is understood that the order of execution may differ from that which is depicted as long as the object of the present invention can be achieved.

According to the above description, the touch control device 10 of the present invention has a small volume which can be freely installed in any place, and can be paired with the controlled system 20 via the wireless communications, thereby providing optimal flexibility for use.

Although the present invention has been explained in relation to its preferred embodiments, it is to be understood that many other possible modifications and variations can be made without departing from the spirit and scope of the invention as hereinafter claimed.

What is claimed is:

1. A touch control device, used for allowing an object to control a controlled system via a wireless transmission, the touch control device comprising:
a light emission module, used for projecting a light signal to form a touch surface;
a first capture module, used for capturing a first reflected signal by reflecting the light signal when the object approaches the touch surface;
a second capture module, used for capturing a second reflected signal by reflecting the light signal when the object approaches the touch surface;
a computing module, electrically connected to the first capture module and the second capture module, used for computing a first capturing angle and a second capturing angle according to the first reflected signal and the second reflected signal, and for performing coordinate calculation to compute a coordinate data of the object; and
a first wireless transmission module, electrically connected to the computing module, used for transmitting the coordinate data to the controlled system via the wireless transmission.

2. The touch control device as claimed in claim 1, wherein the computing module is further used for setting up a detectable area, wherein the detectable area is located within the touch surface.

3. The touch control device as claimed in claim 2, wherein the first capture module and the second capture module capture a plurality of positioning coordinates from the touch surface, and the computing module sets up the detectable area according to the plurality of positioning coordinates.

4. The touch control device as claimed in claim 1, wherein the computing module is further used for filtering out a noise from the first reflected signal and the second reflected signal.

5. The touch control device as claimed in claim 1, wherein a projection angle of the light signal is between 90 degrees and 150 degrees, and the angles captured by the first capture module and the second capture module are between 135 degrees and 225 degrees.

6. A touch control system, used for allowing an object to perform touch control operations, the touch control system comprising:
a touch control device, comprising:
a light emission module, used for projecting a light signal to form a touch surface;
a first capture module, used for capturing a first reflected signal by reflecting the light signal when the object approaches the touch surface;
a second capture module, used for capturing a second reflected signal by reflecting the light signal when the object approaches the touch surface;
a computing module, electrically connected to the first capture module and the second capture module, used for computing a first capturing angle and a second capturing angle according to the first reflected signal and the second reflected signal, and for performing coordinate calculation to compute a coordinate data of the object; and
a first wireless transmission module, electrically connected to the computing module, used for transmitting the coordinate data;
and
a controlled system, comprising:
a second wireless transmission module, used for receiving the coordinate data from the first wireless transmission module;
a conversion module, electrically connected to the second wireless transmission module, used for converting the coordinate data into a control signal; and
a control module, electrically connected to the conversion module, used for processing the control signal.

7. The touch control system as claimed in claim 6, wherein the computing module is further used for setting up a detectable area, wherein the detectable area is located within the touch surface.

8. The touch control system as claimed in claim 7, wherein the first capture module and the second capture module capture a plurality of positioning coordinates from the touch surface, and the computing module sets up the detectable area according to the plurality of positioning coordinates.

9. The touch control system as claimed in claim 8 further comprising an image display device, electrically connected to the controlled system, used for displaying a corresponding image signal according to the control signal.

10. The touch control system as claimed in claim 9, wherein the detectable area corresponds to a range of the image signal.

11. The touch control system as claimed in claim 6, wherein the computing module is further used for filtering out a noise from the first reflected signal and the second reflected signal.

12. The touch control system as claimed in claim 6, wherein the conversion module is further used for performing resolution conversion.

13. The touch control system as claimed in claim 6, wherein the first wireless transmission module and the second wireless transmission module are wireless transmission modules conforming to a Bluetooth communication protocol.

14. The touch control system as claimed in claim 6, wherein a projection angle of the light signal is between 90 degrees and 150 degrees, and the angles captured by the first capture module and the second capture module are between 135 degrees and 225 degrees.

15. A touching control method, used in a touch control system for allowing an object to control a controlled system via a touch control device, the method comprising the following steps:
projecting a light signal to form a touch surface;
capturing a first reflected signal by reflecting the light signal when the object approaches the touch surface;
capturing a second reflected signal by reflecting the light signal when the object approaches the touch surface;
computing a first capturing angle and a second capturing angle according to the first reflected signal and the second reflected signal;
performing coordinate calculation to compute a coordinate data of the object;
transmitting the coordinate data to the controlled system via a wireless transmission; and
converting the coordinate data into a control signal to control the controlled system.

16. The touching control method as claimed in claim 15 further comprising the following step:
setting up a detectable area, wherein the detectable area is located within the touch surface.

17. The touching control method as claimed in claim 16, wherein the step of setting up the detectable area further comprises:
capturing a plurality of positioning coordinates from the touch surface; and
setting up the detectable area according to the plurality of positioning coordinates.

18. The touching control method as claimed in claim 17 further comprising the following step:
displaying a corresponding image signal according to the control signal, wherein the detectable area corresponds to a range of the image signal.

19. The touching control method as claimed in claim 15 further comprising the following step:
filtering out a noise from the first reflected signal and the second reflected signal.

20. The touching control method as claimed in claim 15 further comprising the following step:
performing resolution conversion.

21. The touching control method as claimed in claim 15 further comprising the following step:
pairing the touch control device and the controlled system via the wireless transmission in advance.
